(19) United States
(12) Patent Application Publication
(10) Pub. No.: US 2015/0339093 A1
(43) Pub. Date: Nov. 26, 2015

(54) DISPLAY DEVICE AND METHOD OF CONTROLLING THEREFOR

(71) Applicant: LG ELECTRONICS INC., Seoul (KR)

(72) Inventors: Eunhyung CHO, Seoul (KR); Doyoung LEE, Seoul (KR)

(73) Assignee: LG ELECTRONICS INC., Seoul (KR)

(21) Appl. No.: 14/490,031

(22) Filed: Sep. 18, 2014

(30) Foreign Application Priority Data
May 22, 2014 (KR) 10-2014-0061441

(51) Int. Cl. G06F 3/14

(52) U.S. Cl. CPC G06F 3/1431

(57) ABSTRACT

A display device including two or more display areas is disclosed. The display device includes a task bar between the two or more display areas. And, the task bar includes an icon and an indicator. The indicator indicates a display area to which an execution window of an application is assigned.

This application claims the benefit of the Korean Patent Application No. 10-2014-0061441, filed on May 22, 2014, which is hereby incorporated by reference as if fully set forth herein.

### BACKGROUND OF THE INVENTION

1. Field of the Invention

The present specification relates to a display device and a method of controlling therefor.

2. Discussion of the Related Art

Technologies utilizing a plurality of display units as a single display device are using to use a wider screen. For instance, as depicted in FIG. 1, two monitors can be connected with a single desktop PC (personal computer). Referring to FIG. 1, an icon A, B, C and D respectively corresponding to an execution window A, B, C and D are indicated in a task bar at the bottom.

Yet, such a legacy task bar as shown in FIG. 1 informs a user of an application currently executing only. The legacy task bar cannot inform the user of whether an execution window of the application is activated or a position to which the application is assigned. Hence, in case that a plurality of applications are executed, it is difficult for the user to determine a display unit to which an application is assigned.

Recently, in order to provide a wider display while mobility of a portable device is maintained, a study on a foldable display, a rollable display, a flexible display and the like has been performing. The above-mentioned displays may have a plurality of display areas. Hence, the aforementioned problem may occur in a portable display device as well.

### SUMMARY OF THE INVENTION

Accordingly, the present specification is directed to an apparatus and method thereof that substantially obviate one or more problems due to limitations and disadvantages of the related art. An object of the present specification is to provide a method of efficiently controlling an application assigned to a display device using an enhanced task bar and an apparatus therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a display device includes a display unit configured to include a first display area and a second display area and a processor configured to control the display unit, the processor further configured to set a task bar between the first display area and the second display area, the processor further configured to execute an application including one or more execution windows, the processor further configured to assign each of the one or more execution windows to the first display area or the second display area. The task bar includes a representative image of the application and one or more indicators indicating direction information on a display area to which the one or more execution windows are assigned and each of the one or more indicators corresponds to each of the one or more execution windows.

The processor can display the one or more indicators near the representative image of the application. If one execution window of the one or more execution windows is assigned to the first display area, the processor can display an indicator in a direction of the first display area from the image. If one execution window of the one or more execution windows is assigned to the second display area, the processor can display an indicator in a direction of the second display area from the image.

The processor can adjust a distance between the image and an indicator corresponding to an execution window based on a distance between a position of the task bar and a position to which the execution window is assigned.

The processor can adjust a position of the indicator based on an angle between the image and the execution window.

Meanwhile, if a display mode of the display device is modified into a portrait mode or a landscape mode, the processor maintains a display position of the one or more indicators and can display the image in a manner of rotating the image in accordance with the modified display mode.

Meanwhile, the processor can change a display attribute of an indicator corresponding to an execution window based on activation of the execution window.

The display attribute of the indicator can include at least one selected from a group consisting of a transparency, color, chroma, brightness, size and shape.

Meanwhile, if an indicator corresponding to an execution window moves from a first side of the image to a second side corresponding to an opposite side of the first side, the processor can assign the execution window to a display area of a direction to which the indicator has moved.

If the image is swiped to a direction of the first display area, the processor assigns the one or more execution windows to the first display area, if the image is swiped to a direction of the second display area, the processor can assign the one or more execution windows to the second display area.

If an indicator is dragged or slid away from the image, the processor can terminate an execution window corresponding to the indicator.

And, if the execution window corresponding to the indicator is terminated, the processor can terminate a display of the indicator.

Meanwhile, if the image is dragged outside the task bar, the processor can terminate at least one of the one or more execution windows and the application.

And, if at least one of the one or more execution windows and the application is terminated, the processor can terminate a display of the image.

Meanwhile, the indicator can include a directional shape.

Meanwhile, the task bar can be set to at least one of an area of the first display area adjacent to the second display area and an area of the second display area adjacent to the first display area.

The task bar can be set to at least one of the first display area and the second display area based on at least one length of the first display area and the second display area.

The second display area corresponds to a folding display area connected with the first display area and the task bar can be set to at least one of the first display area and the second display area based on a folding state of the first display area and the second display area.

Meanwhile, the display device further includes a third display area controlled by the processor between the first display area and the second display area and the task bar can be set to at least one selected from a group consisting of the first display area between the first display area and the second display area, the second display area and the third display area.

To further achieve these objects and other advantages and in accordance with the purpose of the invention, as embodied and broadly described herein, according to a different embodiment, a computer-readable storing device including processor-executable commands includes a processor. If the processor-executable commands are executed, the processor can set a task bar between a first display area and a second display area, execute an application containing one or more execution windows and assign each of the one or more execution windows to the first display area or the second display area. The task bar includes one or more indicators indicating a representative image of the application and direction information on a display area to which the one or more execution windows are assigned and each of the one or more indicators corresponds to each of the one or more execution windows.

To achieve these objects and other advantages and in accordance with the purpose of the invention, as embodied and broadly described herein, a method of controlling a display device includes the steps of setting a task bar between a first display area and a second display area, executing an application including one or more execution windows and assigning each of the one or more execution windows to the first display area or the second display area. The task bar includes one or more indicators indicating a representative image of the application and direction information on a display area to which the one or more execution windows are assigned and each of the one or more indicators corresponds to each of the one or more execution windows.

According to the aforementioned various embodiments, a display device and a method of controlling therefor can provide a user with convenience by providing an intuitive user interface to the user.

And, a more enhanced user experience can be provided to a user using an indicator situating at a task bar.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for an example of a related art;

FIG. 2 is a diagram for an example of a display device according to one embodiment of the present specification;

FIG. 3 is a diagram for a configuration of a display device according to one embodiment of the present specification;

FIGS. 4a to FIG. 4c are diagrams for examples of a display device;

FIG. 5 is a diagram for an example of a display device including an indicator of a directional shape;

FIG. 6 is a diagram for an example of an application including a plurality of execution windows;

FIG. 7 is a diagram for one embodiment of changing a task bar according to rotation of a display device;

FIG. 8 is a diagram for one embodiment of an indicator based on an execution window;

FIG. 9 is a diagram for one embodiment of an indicator according to a state of an execution window;

FIG. 10 is a diagram for an example of visual effect according to display activation of an execution window;

FIG. 11 is a diagram for one embodiment of controlling an execution window using an indicator;

FIG. 12 is a diagram for a different embodiment of controlling an execution window using an indicator;

FIG. 13 is a diagram for one embodiment of controlling an execution window using an icon;

FIG. 14 is a diagram for a different embodiment of controlling an execution window using an icon;

FIG. 15 is a diagram for one embodiment of a task bar based on a form of a display device;

FIG. 16 is a diagram for a different embodiment of a task bar based on a form of a display device;

FIG. 17 is a flowchart for a method of controlling a display device according to one embodiment.

### DETAILED DESCRIPTION OF THE INVENTION

Reference will now be made in detail to the preferred embodiments of the present specification, examples of which are illustrated in the accompanying drawings. While the embodiments have been concretely described with reference to the attached diagrams and the contents written on the diagrams, a scope of claims may be non-restricted or non-limited to the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

And, structural or functional explanations, which are specified for embodiments according to a concept of the present disclosure, are described to explain embodiments according to the concept of the present specification only. Hence, the embodiments according to the concept of the present specification can be implemented in various forms rather than construed as the embodiments explained in the present specification only.

Since the embodiments according to the concept of the present specification can have various modifications and forms, the present specification is explained in detail in a manner of showing examples of specific embodiments in drawings. Yet, the embodiments according to the concept of the present specification may be non-limited to the specified disclosure form. Instead, the embodiments according to the concept of the present specification needs to be construed as the embodiments including all changes, equivalents or substitutes included in an idea and a technological scope of the present specification.

Moreover, a terminology, each of which includes such an ordinal number as 1^{st}, 2^{nd} and the like, may be used to describe various components. In doing so, the various components should be non-limited by the corresponding terminologies, respectively. The terminologies are only used for the purpose of discriminating one component from other components. For instance, a 1^{st} component may be named a 2^{nd} component while coming within the scope of the appended claims and their equivalents. Similarly, the 2^{nd} component may be named the 1^{st} component.

In the present application, such a terminology as ‘comprise’, ‘include’ and the like should be construed not as necessarily excluding various components or steps written in the present specification but as including the components or steps in part or further including additional components or steps. And, such a terminology as ‘unit’ written in the present specification indicates a unit processing at least one function or an operation and can be implemented by hardware, software or a combination thereof.

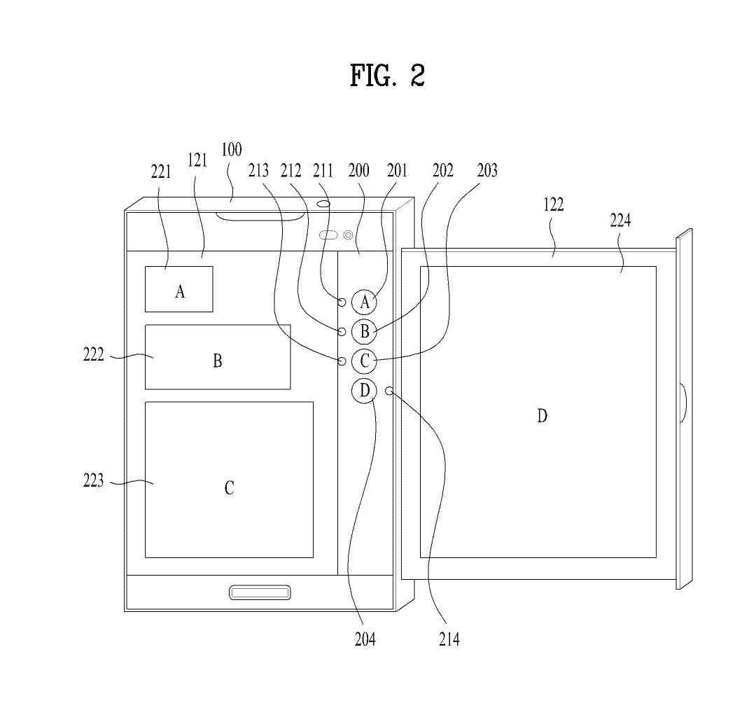

FIG. 2 is a diagram for an example of a display device according to one embodiment of the present specification.

Referring to FIG. 2, a display device 100 includes a first display area 121 and a second display area 122. A task bar 200 is set between the first display area 121 and the second display area 122. The task bar 200 includes icons 201/202/202/204 corresponding to applications and indicators 211/212/213/214 corresponding to execution windows 221/222/223/224 of each of the applications. As mentioned later, the task bar can be displayed either in the first display area 121 or the second display area 122. And, although FIG. 2 shows that the task bar 200 includes a boundary line, the boundary line of the task bar 200 may not be displayed.

According to embodiment of FIG. 2, an application includes a representative image of the application. The representative image of the application includes an icon 201/202/203/204. For instance, an application A includes an icon 201 corresponding to the application A and the icon 201 is displayed in the task bar 200.

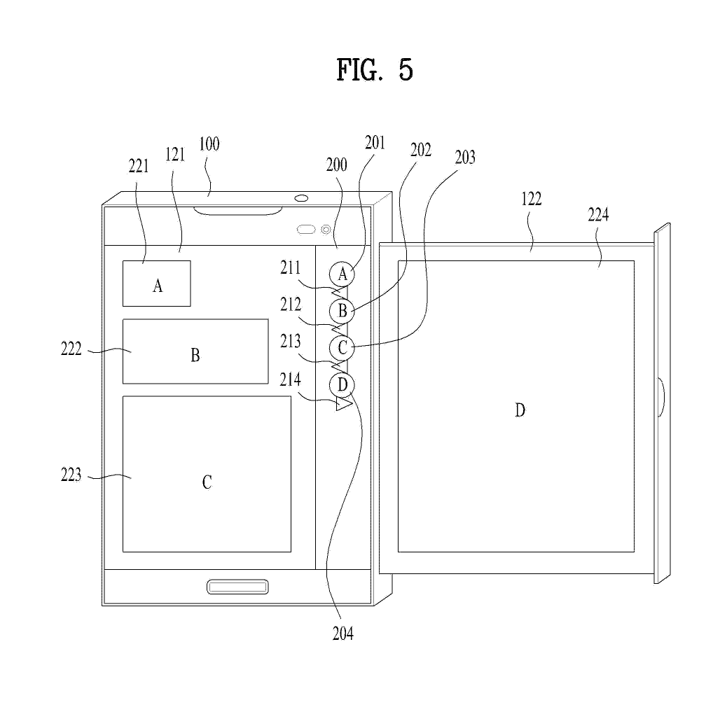

And, indicators 211/212/213/214, which indicate direction information of display areas to which execution windows 221/222/223/224 of each application are assigned, are displayed in the task bar 200. The indicators 211/212/213/214 can be arranged in a manner of being adjacent to the icons 201/202/203/204. Referring to embodiment of FIG. 2, display areas to which the execution windows 221/222/223/224 are assigned can be indicated by arranging the each indicator 211/212/213/214 to the left or the right of the icons 201/202/203/204. For instance, an execution window 221 of the application A is assigned to the first display area 121. In this case, an indicator 211 corresponding to the execution window 221 of the application A is arranged to the left of an icon 201. Hence, a user can check the display area to which the execution window 221 is assigned based on a position of the indicator 211. And, for instance, an execution window 224 of an application D is assigned to the second display area 122. In this case, an indicator 214 corresponding to the execution window 224 of the application D is arranged to the right of an icon 204. In particular, the indicators 211/212/213/214 can be arranged to a direction of the execution windows 221/222/223/224 on the basis of the position of the icons 201/202/203/204. Yet, as described later with reference to FIG. 5, if the indicators 211/222/223/224 have a directional shape, the position of the indicators may be independent of the position of the execution windows 221/222/223/224.

And, the execution windows 221/222/223/224 are displayed in the first and the second display area 121/122. Display of each execution window 221/222/223/224 may be activated or inactivated.

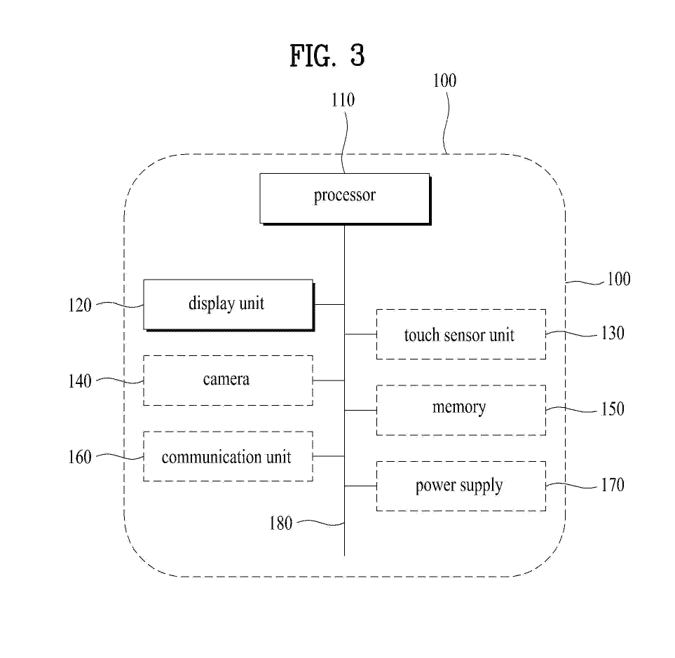

FIG. 3 is a diagram for a configuration of a display device according to one embodiment of the present specification.

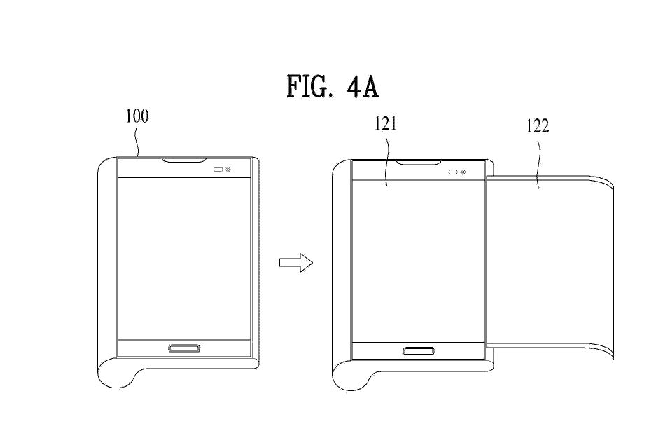

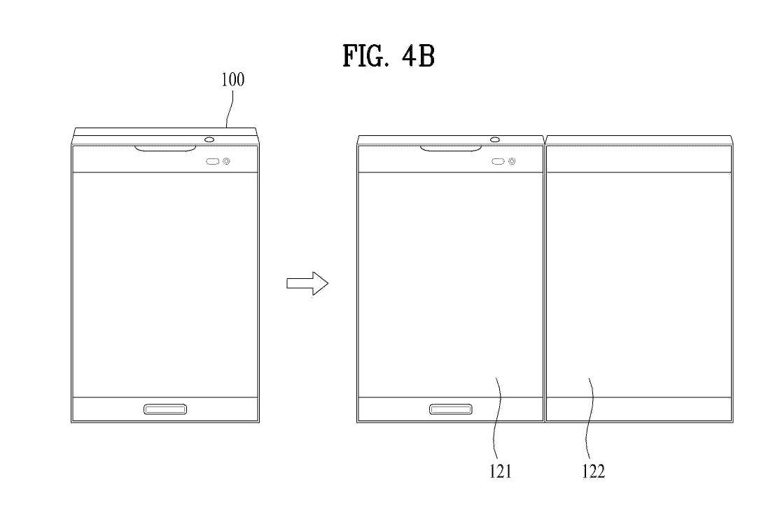

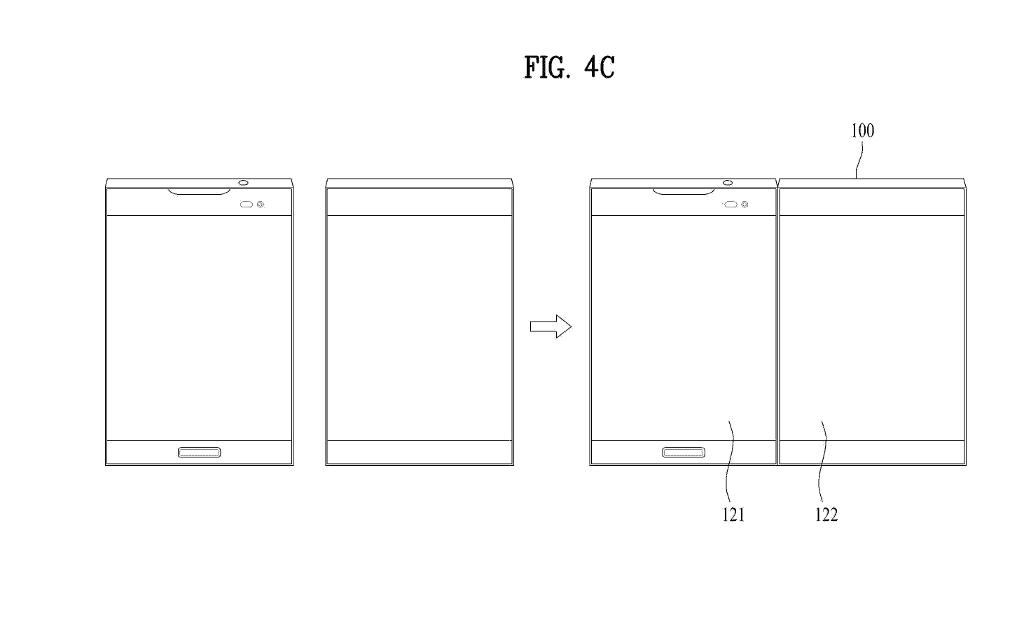

A display device 100 includes a display unit 120 and a processor 110. And, the display device may include a touch sensor unit 130, a camera 140, a memory 150, a communication unit 160 and a power supply 170. And, the display device 100 may further include different configurations not depicted in FIG. 3. Moreover, configurations of the display device 100 may be connected with each other via a bus 180. In embodiment of FIG. 3, the configurations represented by a dotted line are not essential configurations of the display device 100. For instance, power of the display device 100 can be supplied from external and the display device may have a separate external storing device. And, the display unit 120 may include a touch sensor unit 130 and may have various form factors described later with reference to FIGS. 4a to 4c.

FIGS. 4a to FIG. 4c are diagrams for examples of a display device.

In FIG. 2, the display device (100 in FIG. 2) is depicted as an extendible display device. Yet, the display device may include various form factors. Referring to FIG. 4a, the display device 100 includes a rollable display. As the display device 100 is extending, the first display area 121 and the second display area 122 can be distinguished from each other.

And, referring to FIG. 4b, the display device 100 includes a foldable display. As the display device 100 is unfolding, the first display area 121 and the second display area 122 can be distinguished from each other.

And, referring to FIG. 4c, the display device 100 includes an attachable display device. Two display devices may correspond to display devices independent from each other. By combining the two display devices with each other, one display device 100 can be generated.

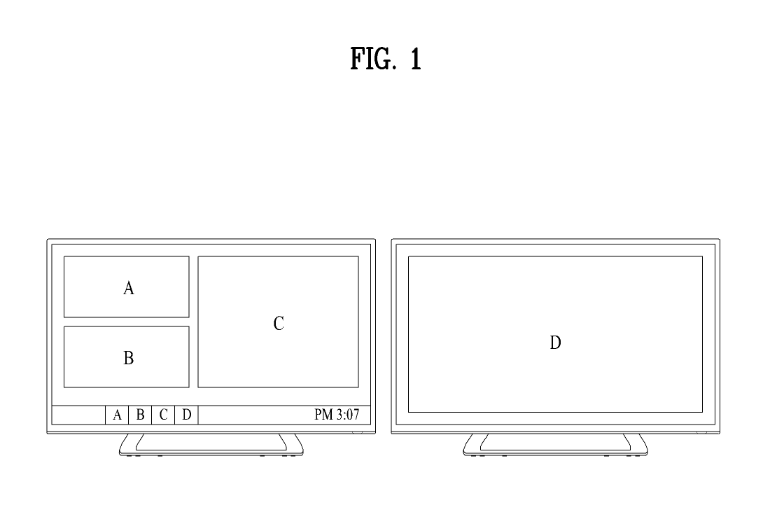

The aforementioned form factors of the display device 100 are just examples. The display device 100 can include a random display device capable of being divided into a first display area 121 and a second display area 122. For instance, the two monitors shown in FIG. 1 can be included in the display device 100.

In the foregoing description, configurations of the display device and embodiments have been described. In the following, various embodiments of the display device is explained. It is apparent that those having ordinary skill in the technical field to which the present specification pertains know that the aforementioned configuration of the display device and embodiments described with reference to FIG. 2 to FIG. 4 can be combined with embodiments described in the following.

FIG. 5 is a diagram for an example of a display device including an indicator of a directional shape.

Indicators 211/212/213/214 depicted in FIG. 5 have a directional shape. Hence, unlike the embodiment of FIG. 2, the indicators in FIG. 5 are not displayed in a direction of execution windows 221/222/223/224 corresponding to the indicators. Yet, since the indicators 211/212/213/214 have the directional shape, a user is able to know display areas 121/122 in which the execution windows 221/222/223/224 are displayed. The indicators 211/212/213/214 can include any other shapes capable of indicating a direction as a triangle, an arrow and the like.

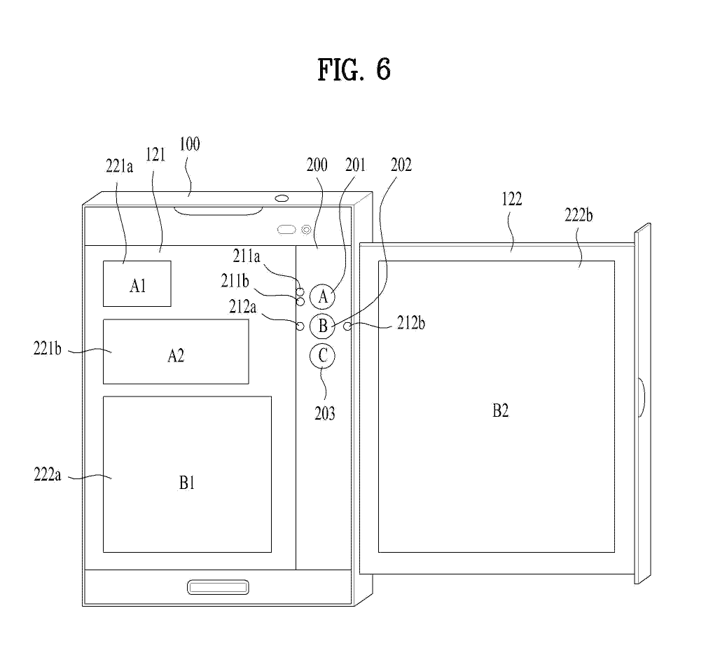

FIG. 6 is a diagram for an example of an application including a plurality of execution windows.

Referring to FIG. 6, an application A includes two execution windows 221a/221b and an application B includes two execution windows 222a/222b. Meanwhile, no execution window is displayed for an application C. Indicators 211a/211b corresponding to the execution windows 221a/221b of the application A are displayed in a manner of being adjacent to an icon 201 of the application A. Since the execution windows 221a/221b of the application A are positioned at the left of a task bar 200, the indicators 211a/211b are displayed in the left of the icon 201. And, since execution windows 222a/222b of an application B are positioned at the left and the right of the task bar 200, respectively, indicators 212a/212b are displayed in the left and the right of an icon 202, respectively. Meanwhile, since an execution window of the application C is not activated, an indicator corresponding to the execution window is not displayed.

As depicted in FIG. 6, one application can include one or more execution windows and an indicator corresponding to each execution window can be displayed. Moreover, whether to display an indicator can be determined based on activation of an execution window or display activation of the execution window.

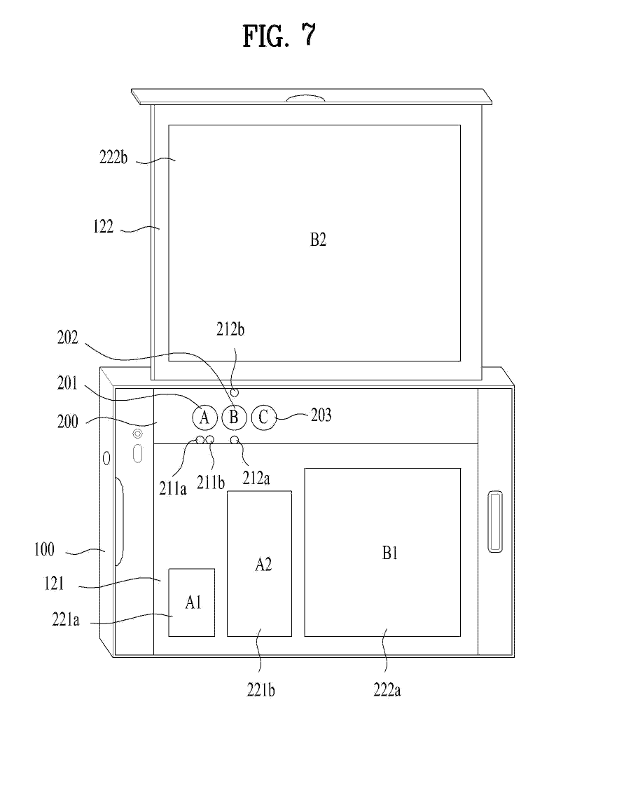

FIG. 7 is a diagram for one embodiment of changing a task bar according to rotation of a display device.

Referring to FIG. 7, a display mode of the display device 100 changes. The display mode of the display device 100 can include a portrait mode and a landscape mode. A change of the display mode of the display device 100 may occur based on a change of an orientation of the display device 100. For instance, referring to FIG. 7, the display device 100 has rotated 90 degrees counterclockwise from the display device 100 shown in FIG. 6. In this case, the display mode of the display device 100 can change based on the rotation of the display device 100. Yet, as depicted in FIG. 7, a direction of the execution windows heading to the task bar 200 is identical to the direction depicted in FIG. 6. Hence, although the display mode of the icons 201/202/203 and the display mode of the execution windows 221a/221b/222a/222b change, positions of the indicators 211a/211b/212a/212b are maintained in a manner of being identical to the positions of the indicators shown in FIG. 6. In particular, if the display mode of the display device 100 changes to the portrait mode or the landscape mode, the display device 100 maintains the positions of the indicators 211a/211b/212a/212b and can display the icons 201/202/203 in a manner of rotating the icons according to the changed display mode.

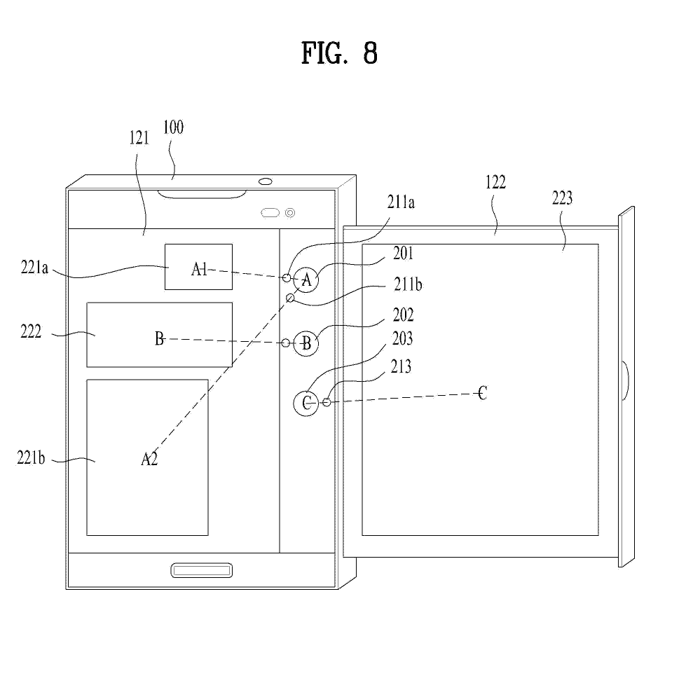

FIG. 8 is a diagram for one embodiment of an indicator based on an execution window.

Referring to FIG. 8, indicators 211a/211b of an application A are positioned on lines between an icon 201 and execution windows 221a/221b. In particular, a position of an indicator can be adjusted based on an angle between an icon and an execution window. And, the position of the indicator can be adjusted based on a distance between the icon and the execution window. For instance, a distance between an execution window 221a of an application A and an icon 201 is shorter than a distance between an execution window 221b of the application A and the icon 201. Hence, the indicator 211a can be positioned in a manner of being nearer to the icon 201 compared to the indicator 211b corresponding to the execution window 221b.

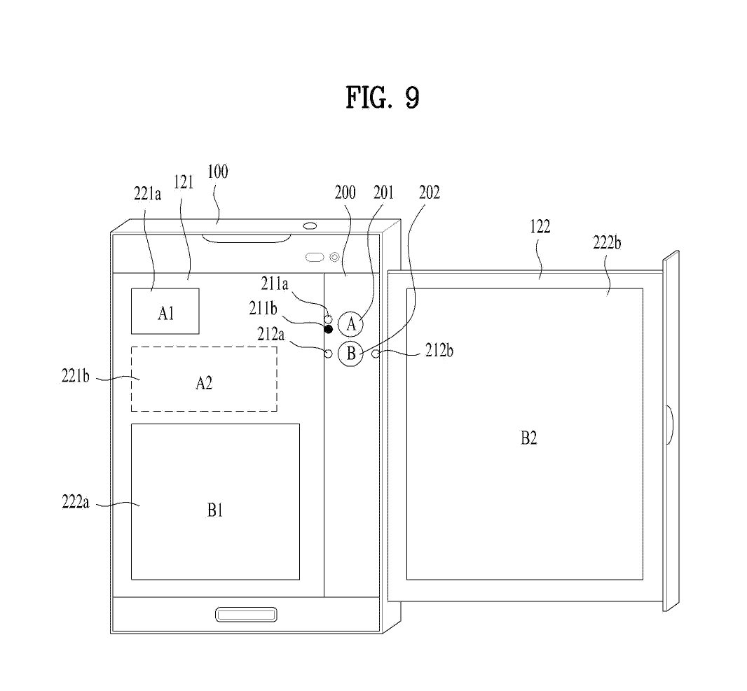

FIG. 9 is a diagram for one embodiment of an indicator according to a state of an execution window.

Referring to FIG. 9, a display of an execution window A1 221a of an application A is activated. On the contrary, a display of an execution window A2 221b is inactivated. In this case, a display attribute of an indicator 211a/211b may change based on activation of the execution window 221a/221b corresponding to the indicator. For instance, referring to FIG. 9, the indicator 211a has a shape of an empty dot, whereas a different indicator 211b may have a shape of a dot with which an inside of the dot is filled. And, the change of the display attribute of the indicator, which is changed based on the activation of the execution window, may include a change of at least one selected from a group consisting of a transparency, a color, a chroma, brightness, size and a shape of the indicator.

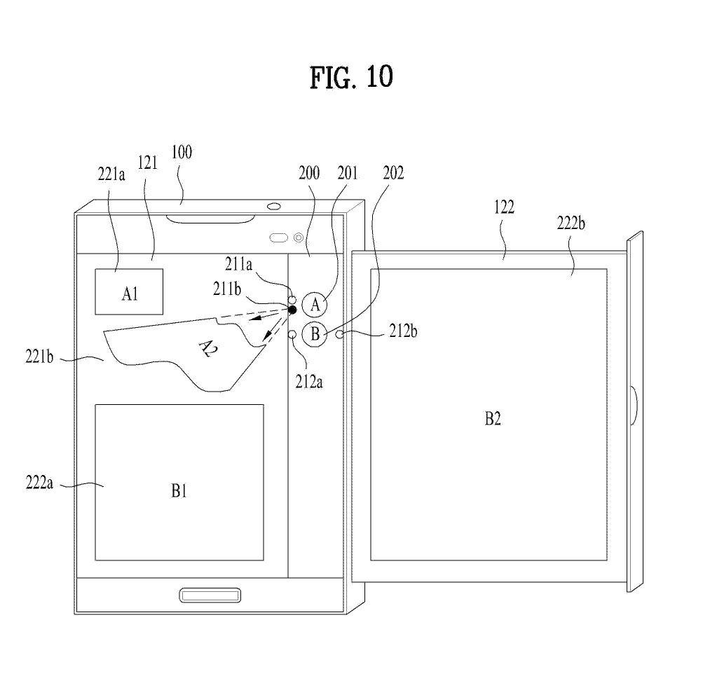

FIG. 10 is a diagram for an example of visual effect according to display activation of an execution window.

Referring to FIG. 10, an execution window A2 221b pops-up with a visual effect from an indicator 211b corresponding to the executing window. For instance, if the execution window A2 221b is inactivated, the execution window A2 221b may be sucked down into the indicator 211b. And, as mentioned earlier with reference to FIG. 9, a display attribute of the indicator 211b may change based on inactivation or activation of the execution window A2 221b. Moreover, the execution window A2 221b may pop-up from the indicator 211b or may be sucked down into the indicator 211b by an effect also called as a genie effect.

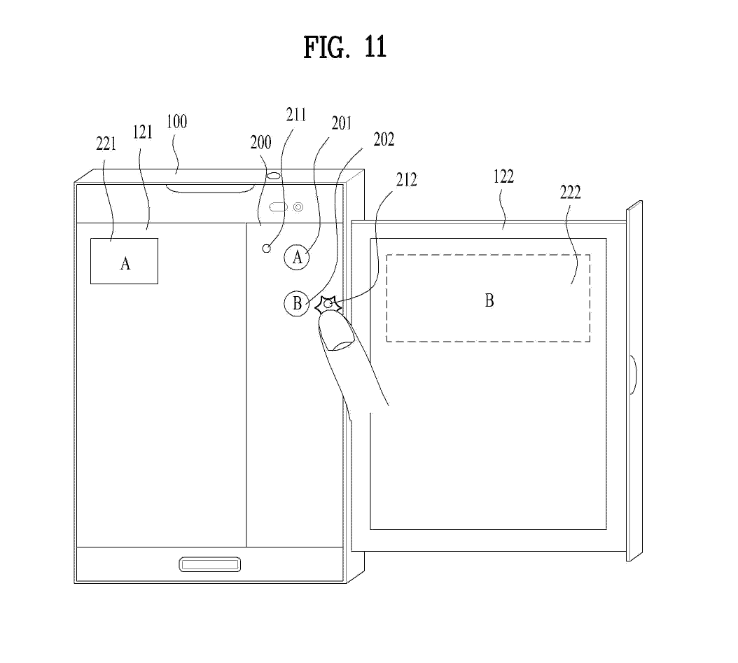

FIG. 11 is a diagram for one embodiment of controlling an execution window using an indicator.

Referring to FIG. 11, if an indicator 212 is touched, an execution window 222 corresponding to the indicator can be activated or inactivated. Hence, the execution window 222 corresponding to the indicator can be controlled by the indicator 212. FIG. 11 shows that activation/inactivation of the corresponding execution window 222 is switched when the indicator 212 is touched. Yet, this is just an example. Various control methods can be used.

For instance, if the indicator 212 is dragged or slid away from an icon 202, an execution window 222 corresponding to the indicator 212 can be terminated or inactivated. And, if the corresponding execution window 222 is terminated or inactivated, a display attribute of the indicator 212 can be modified. And, if the corresponding execution window 222 is terminated, a display of the indicator 212 may be terminated.

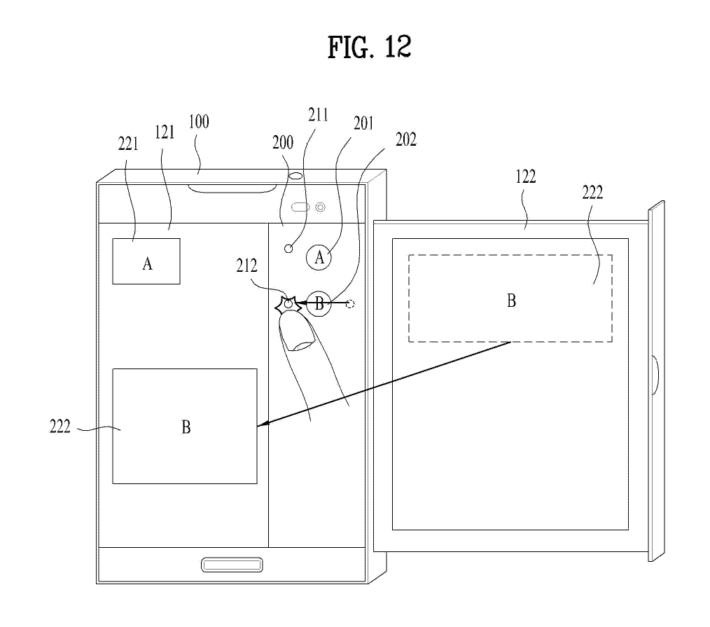

FIG. 12 is a diagram for a different embodiment of controlling an execution window using an indicator.

Referring to FIG. 12, an indicator 212 moves from the right side of the icon 202 to the left side of the icon. The indicator 212 can be moved by a drag or a slide. In this case, an execution window 222 corresponding to the indicator 212 moves based on a direction to which the indicator 212 has moved. Referring to FIG. 12, the indicator 212 moves to a direction of a first display area 121. Hence, the execution window 222 moves from a second display area 122 to the first display area 121. By doing so, the display area 121 or 122 to which the execution window 222 is assigned can be switched based on the move of the indicator 212.

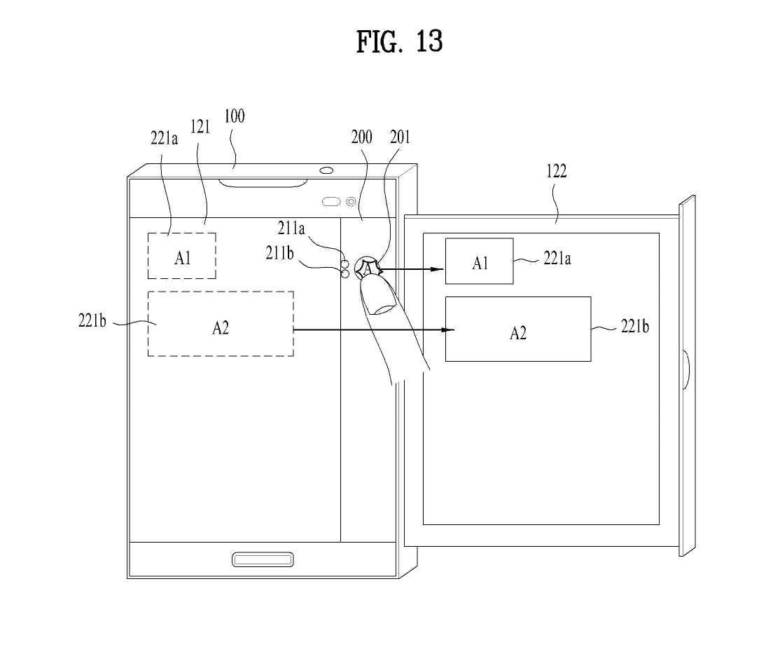

FIG. 13 is a diagram for one embodiment of controlling an execution window using an icon.

Referring to FIG. 13, an icon 201 is swiped to a direction of a second display area 122. In this case, execution windows 221a/221b of an application A can be assigned to the second display area 122. And, if the icon 201 is swiped to a direction of a first display area 121, the execution windows 221a/221b of the application A can be assigned to the first display area 121. Hence, if the icon 201 is swiped, all execution windows of an application corresponding to the icon can be assigned to other display area.

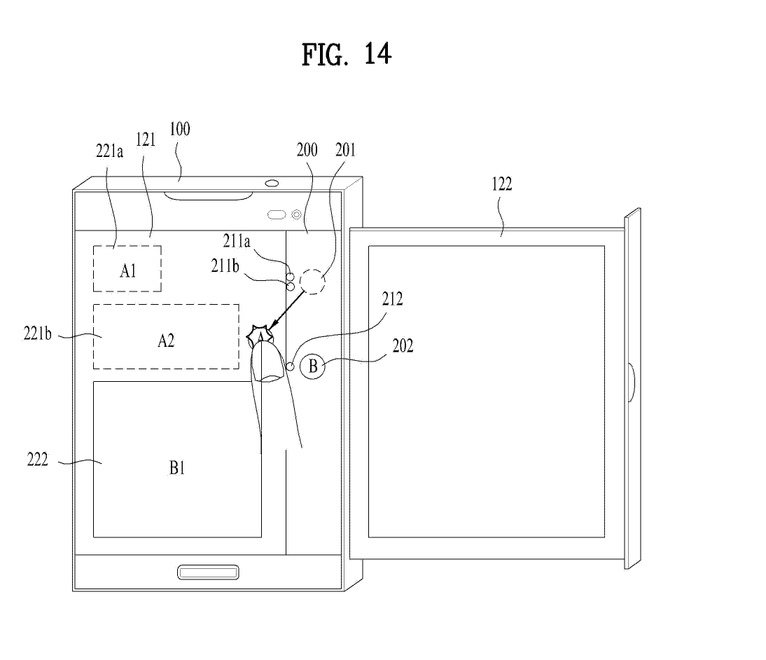

FIG. 14 is a diagram for a different embodiment of controlling an execution window using an icon.

Referring to FIG. 14, if an icon 201 is dragged to an outside of a task bar 200, execution windows 221a/221b of an application corresponding to the icon can be terminated. And, if the icon 201 is dragged outside the task bar 200, the application (application A) itself corresponding to the icon can be terminated. In this case, the display device 100 can terminate a display of the icon 210.

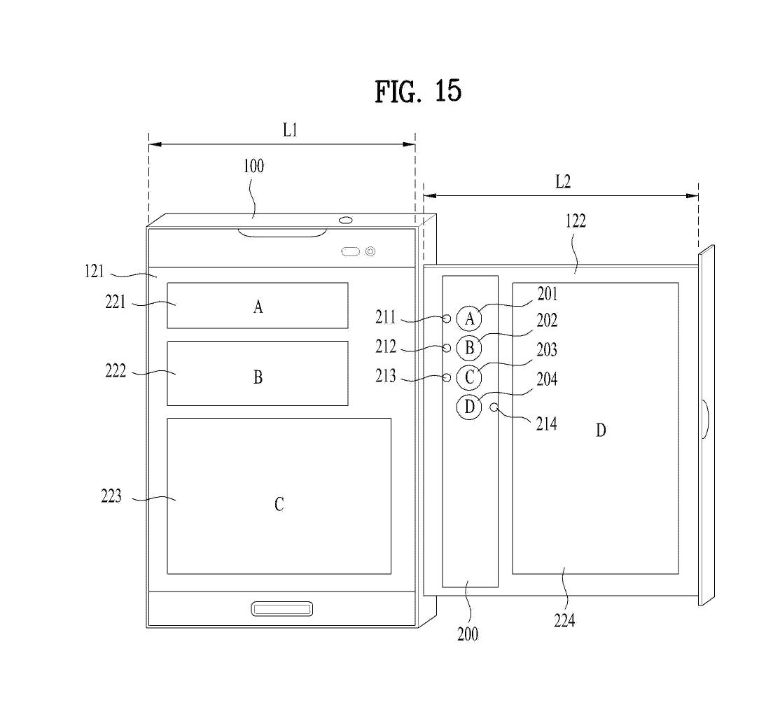

FIG. 15 is a diagram for one embodiment of a task bar based on a form of a display device.

Referring to FIG. 2, a task bar 200 is displayed in a first display area 121 (refer to FIG. 2). Yet, referring to embodiment of FIG. 15, the task bar 200 is displayed in a second display area 122. In particular, the task bar 200 can be set to the first display area 121 and/or the second display area 122 adjacent to an area between the first display area 121 and the second display area 122.

And, a display area of the task bar 200 can be configured based on a length (L1) of the first display area 121 and a length (L2) of the second display area 122. For instance, if the L2 is longer than the L1, the task bar 200 can be set to the second display area 122. On the contrary, if the L1 is longer than the L2, the task bar 200 can be set to the first display area 121. Hence, when the display device 100 corresponds to an extendible display, if the length of the second display area 122 increases, the position of the task bar 200 may change.

And, for instance, the display device 100 may correspond to a folding display device. In this case, the task bar 200 can be set to the first display area 121 and/or the second display area 122 based on a folding state of the display device 100. For instance, the task bar 200 is set to the first display area 121 in a folded state and may be set to the second display area 122 in an unfolded state. On the contrary, the task bar 200 may be set to the second display area 122 in the folded state.

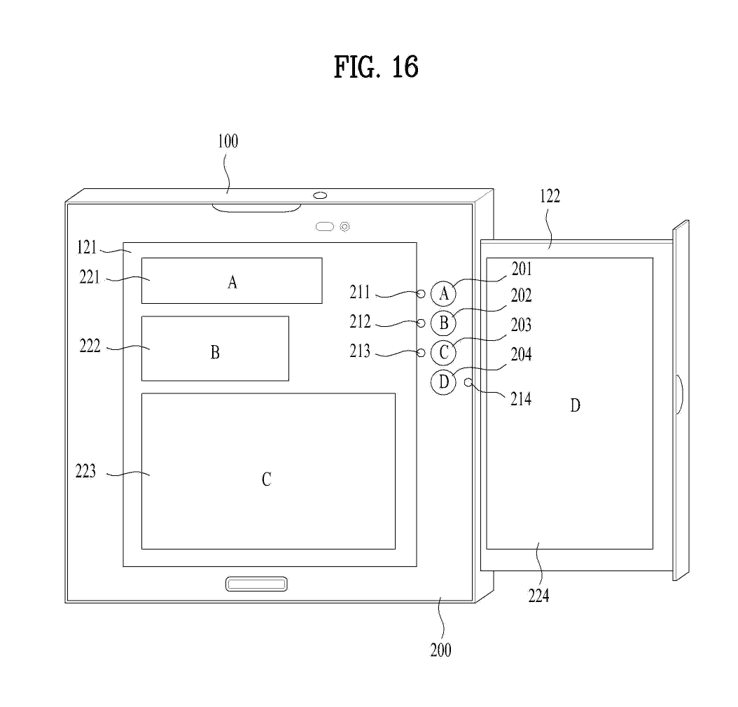

FIG. 16 is a diagram for a different embodiment of a task bar based on a form of a display device.

Referring to FIG. 16, the display device 100 includes a separate area between the first display area 121 and the second display area 122. As depicted in embodiment of FIG. 16, the separate area may be positioned on a bezel of the display device 100. Referring to FIG. 16, the task bar 200 is displayed on the separate display area. Yet, as mentioned earlier with reference to FIG. 15, the task bar 200 can be set to various positions (a position adjacent to an area between the first display area 121 and the second display area 122) of the display device 100.

In the foregoing description, configurations of the display device and embodiments have been explained. In the following, a method of controlling the display device is explained. It may be comprehensible for those skilled in the art that the configuration of the display device and the embodiments mentioned earlier with reference to FIG. 2 to FIG. 16 can be combined with each other or may be substituted with each other.

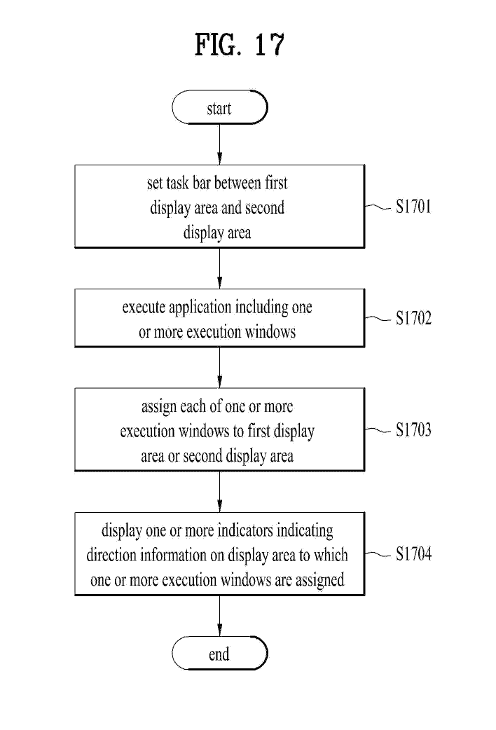

FIG. 17 is a flowchart for a method of controlling a display device according to one embodiment.

A task bar is set between a first display area and a second display area [S1701]. As mentioned earlier with reference to FIGS. 2, 15 and 16, the task bar can be set to various positions. And, as mentioned earlier with reference to FIG. 2 to FIG. 4c, the display device including the first display area and the second display area can have various configurations and form factors.

An application including one or more execution windows is executed [S1702] and each of the one or more execution windows are assigned to the first display area or the second display area [S1703]. One or more indicators, which indicates direction information on the display area to which the one or more execution windows are assigned, are displayed [S 1704]. As mentioned earlier with reference to FIG. 2 and FIG. 5 to FIG. 8, the indicator may have various shapes and can be displayed in various positions.

And, it may be easily comprehensible for those skilled in the art that various methods of controlling the display device mentioned earlier with reference to FIG. 9 to FIG. 16 can be combined with the aforementioned method of controlling the display device.

A display device according to the present specification and a method of controlling therefor may not limitedly apply to the composition and method of the aforementioned embodiments. The aforementioned embodiments may be configured in a manner of being selectively combined the whole of the embodiments or a part of the embodiments to achieve various modifications.

Meanwhile, a display device according to the present specification and a method of controlling therefor can be implemented with a software readable by a processor in a recording media readable by the processor, which is equipped in the display device. The recording media readable by the processor may include all kinds of recording devices for storing data capable of being read by the processor. The examples of the recording media readable by the processor may include a ROM, a RAM, a CD-ROM, a magnetic tape, a floppy disc, an optical data storing device and the like. The recording media readable by the processor are distributed to the computer systems connected by a network and codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

What is claimed is:

1. A display device, comprising:
a display unit comprising a first display area and a second display area; and
a processor configured to control the display unit,
wherein the processor is further configured to:
set a task bar between the first display area and the second display area,
execute an application containing one or more execution windows, and
assign each of the one or more execution windows to the first display area or the second display area,
wherein the task bar comprises a representative image of the application and one or more indicators indicating direction information on a display area to which the one or more execution windows are assigned, and
wherein each of the one or more indicators corresponds to each of the one or more execution windows.

2. The display device of claim 1,
wherein the processor is further configured to:
display the one or more indicators near the representative image of the application,
if one execution window of the one or more execution windows is assigned to the first display area, display an indicator in a direction of the first display area from the image, and
if one execution window of the one or more execution windows is assigned to the second display area, display an indicator in a direction of the second display area from the image.

3. The display device of claim 2, wherein the processor is further configured to adjust a distance between the image and an indicator corresponding to an execution window based on a distance between a position of the task bar and a position to which the execution window is assigned.

4. The display device of claim 2, wherein the processor is further configured to adjust a position of the indicator based on an angle between the image and the execution window.

5. The display device of claim 2, wherein the processor is further configured to, if a display mode of the display device is modified into a portrait mode or a landscape mode, maintain a display position of the one or more indicators and display the image in a manner of rotating the image in accordance with the modified display mode.

6. The display device of claim 1, wherein the processor is further configured to change a display attribute of an indicator corresponding to an execution window based on activation of the execution window.

7. The display device of claim 6, wherein the display attribute of the indicator comprises at least one selected from a group consisting of a transparency, color, chroma, brightness, size and shape.

8. The display device of claim 2, wherein the processor is further configured to, if an indicator corresponding to an execution window moves from a first side of the image to a second side corresponding to an opposite side of the first side, assign the execution window to a display area of a direction to which the indicator has moved.

9. The display device of claim 1, wherein the processor is further configured to:
if the image is swiped to a direction of the first display area, assign the one or more execution windows to the first display area, and
if the image is swiped to a direction of the second display area, assign the one or more execution windows to the second display area.

10. The display device of claim 2, wherein the processor is further configured to, if an indicator is dragged or slid away from the image, terminate an execution window corresponding to the indicator.

11. The display device of claim 10, wherein the processor is further configured to, if the execution window corresponding to the indicator is terminated, terminate a display of the indicator.

12. The display device of claim 1, wherein the processor is further configured to, if the image is dragged outside the task bar, terminate at least one of the one or more execution windows and the application.

13. The display device of claim 12, wherein the processor is further configured to, if at least one of the one or more execution windows and the application is terminated, terminate a display of the image.

14. The display device of claim 1, wherein the indicator comprises a directional shape.

15. The display device of claim 1, wherein the task bar is set to at least one of an area of the first display area adjacent to the second display area and an area of the second display area adjacent to the first display area.

16. The display device of claim 15, wherein the task bar is set to at least one of the first display area and the second display area based on at least one length of the first display area and the second display area.

17. The display device of claim 15, wherein the second display area corresponds to a folding display area connected with the first display area and wherein the task bar is set to at least one of the first display area and the second display area based on a folding state of the first display area and the second display area.

18. The display device of claim 1, further comprising a third display area controlled by the processor between the first display area and the second display area,
wherein the task bar is set to at least one selected from a group consisting of the first display area between the first display area and the second display area, the second display area and the third display area.

19. A computer-readable storing device containing processor-executable commands, wherein the processor-executable commands, when executed by a processor, cause the processor to:
set a task bar between a first display area and a second display area,
execute an application containing one or more execution windows, and
assign each of the one or more execution windows to the first display area or the second display area,
wherein the task bar comprises one or more indicators indicating a representative image of the application and direction information on a display area to which the one or more execution windows are assigned, and
wherein each of the one or more indicators corresponds to each of the one or more execution windows.

20. A method of controlling a display device, comprising the steps of:
setting a task bar between a first display area and a second display area;
executing an application containing one or more execution windows; and
assigning each of the one or more execution windows to the first display area or the second display area,
wherein the task bar comprises one or more indicators indicating a representative image of the application and direction information on a display area to which the one or more execution windows are assigned and wherein each of the one or more indicators corresponds to each of the one or more execution windows.
